(19) United States
(12) Patent Application Publication
(10) Pub. No.: US 2024/0114927 A1
(43) Pub. Date: Apr. 11, 2024

(54) PET FOOD

(71) Applicant: Mars, Incorporated, McLean, VA (US)

(72) Inventors: Bastian LAMMERS, Verden (DE); Sofia PALEARI, Sovico (IT); Raluca-Ioana ALEXA, Doorwerth (NL); Xiaoxue ZHENG, Shenzhen (CN)

(73) Assignee: Mars, Incorporated, McLean, VA (US)

(21) Appl. No.: 18/371,238

(22) Filed: Sep. 21, 2023

Related U.S. Application Data
(62) Division of application No. 15/775,033, filed on May 10, 2018, now abandoned.

(30) Foreign Application Priority Data
Nov. 10, 2015 (GB) 1519854.2

(51) Int. Cl. A23K 20/163; A23K 20/147; A23K 50/48

(52) U.S. Cl. CPC A23K 20/163; A23K 20/147; A23K 50/48

(57) ABSTRACT

The present invention relates to a solid pet food component which comprises a mixture of curdlan and a protein and which has a moisture content of at least 40%. The present invention also relates to a wet pet food which contains a solid, pet food components, as described above. The present invention also related to a method of making the solid pet food component and a method of making the wet pet food, as described above.

### CROSS-REFERENCE TO RELATED APPLICATIONS

This application is a divisional of U.S. application Ser. No. 15/775,033, filed May 10, 2018, which is a U.S. national stage application under 35 U.S.C. § 371 of International Application No. PCT/EP2016/077364, filed Nov. 10, 2016, which claims priority to GB Patent Application No. 1519854.2, filed Nov. 10, 2015, the entire contents of each priority application is incorporated herein by reference.

### FIELD OF THE DISCLOSURE

The present invention relates to a solid pet food component which comprises a mixture of curdlan and a protein and which has a moisture content of at least 40%. The present invention also relates to a wet pet food which contains a solid pet food component, as described above. The present invention also relates to a method of making the solid pet food component and a method of making the wet pet food, as described above.

### BACKGROUND OF THE DISCLOSURE

Petfood products contain proteins from different sources. A large part of current protein sources are from animal products with high functionality. Highly functional proteins have certain water binding and fat binding properties that result in desirable texture formation and preservation of the end products.

In the future, such protein sources may be less available as raw materials for the petfood industry as their use in human food production increases.

However, lower functional proteins do not possess the ability to form solid texture (water binding and fat binding properties to make pet food products having the desired texture formation), especially using current recipes and current processing routes. The desired aesthetic is an essential requirement to pet owners as they feed their animals. Texture is also a highly important characteristic of pet foods, to the pet animals themselves, for the purposes of enjoyment of eating.

The purpose of this invention is to address these problems.

### SUMMARY OF THE DISCLOSURE

Accordingly, a first aspect of the present invention provides a solid pet food component which comprises a mixture of curdlan and a protein and which has a moisture content of at least 40%.

The solid pet food component is in the form of an aggregate, for example a chunk. The protein is preferably (or at least a majority of the protein in that at least 50% by weight of the protein) in the form of a particulate (including a powder or meal) which in the presence of a lubricant, such as water, forms a slurry or paste and is dispersed, suspended or in an emulsion form throughout the solid pet food component, preferably in a substantially homogenous mixture. The protein may be in dry or wet form.

The protein may be a low functional protein. Such a low functional protein either cannot or does not possess the ability to form solid texture (the water binding and fat binding properties to form the desired texture or organoleptic properties). In comparison, proteins having textural functional properties or water-binding proteinaceous material can more easily be used to form the required texture/organoleptic properties in the absence of curdlan. A problem to be addressed is the use of proteins with less functionality, to form a useful aggregate composition. It has been found that such low functional proteins (preferably in particulate form), mixed with curdlan and being in a composition with at least 40% moisture form a solid pet food component, according to the first aspect of the invention, and have the desired texture/organoleptic properties. Low functional proteins may be low functional as they occur in nature or may become low functional during changes in conditions such as pH, pressure and/or temperature as obtained from a rendering process. These changes produce proteins which are denatured. Such denaturation is where the shape of the protein is altered so that it is no longer functional.

### BRIEF DESCRIPTION OF THE FIGURES

The invention may be described further in relation to the following figures:

FIG. 1 is an example of data output from a Texture Profile Analyzer, obtained as described in Example 1.

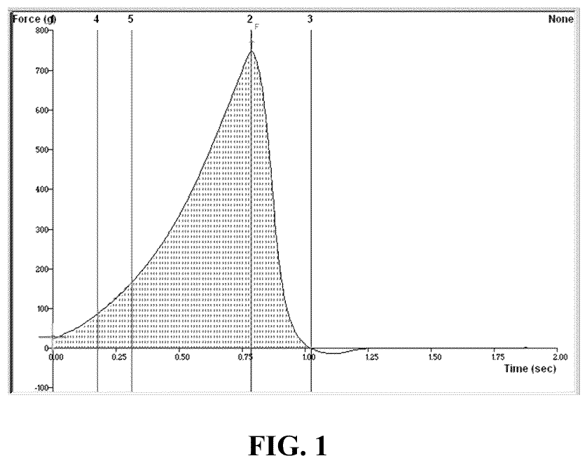

### DETAILED DESCRIPTION OF THE DISCLOSURE

Curdlan is a hydrocolloid. It provides structure to meat analogue chunks (solid pet food components) in which low functional proteins are used. Without the use of curdlan it would not be possible to obtain the chunk texture and the chunks would not self support themselves. A main advantage of using curdlan is avoiding the use of high functional or functional proteins, which mainly derive from animal material, which are forecasted to be less available for pet food in the future. In contrast, by-products from animals, which have low or no functionality, can be used according to the present invention.

Curdlan sets up an irreversible solid form only upon heating (>80° C.) which is a unique property compared to other hydrocolloids which set up a reversible (temperature-dependant) structure or need ion addition to create a solid aggregate. Due to this property, a standard process for chunk production can be used to process the first aspect of the present invention, without the need to set up a new process.

Curdlan also provides a structure that does not change upon further heating and/or retorting. Curdlan is tasteless, odourless and colourless. Together with the other ingredients according to the first and second aspects of the invention it retains palatability.

Curdlan is not soluble in water and needs to be dispersed in water to create a suitable texture. Dispersion of powdered curdlan has previously been achieved by the use of an alkaline solution (curdlan becomes soluble at pH>11) and/or the use of a thickener. Surprisingly, no such alkaline solution is required to produce the solid pet food component of the first aspect of the invention. In fact, the pet food of the first aspect preferably has a pH of <11, preferably <8.

Curdlan is a high molecular weight polymer of glucose, beta-(1→3)-glucan. Curdlan can be produced in high yield by fermentation culture of strains of Alcaligenes faecalis var. myxogenes, or Agrobacterium radiobacter NCIM2443. Its production is well documented in the art. The fact that curdlan is produced in high quantities, at high purity by a laboratory process enables sufficient quantities to be produced without relying on natural sources of hydrocolloids.

The solid pet food component of the first aspect of the invention has a moisture content of at least 40% and may have a moisture content of at least 45%, 50%, 55%, 60%, 65%, 70%, 75%, 80%, 85%, 90% or 95%.

The curdlan is preferably present in the product in the range of 0.5% to 25% (on a wet weight basis). The curdlan is preferably present in a percentage lower than 10%, 9%, 8%, 7%, 6%, 5%, 4%, 3%, 2% or 1% and may be present in the ranges 0.05% to 25%, more preferably 0.25 to 10%, or 0.5 to 5% or 2 to 4%, or around 3% (on a wet weight basis). The precise amount of curdlan may be determined in combination with the amount of moisture and type of protein being used. The skilled person can easily determine the amount of each component needed by tests as described herein.

The protein in the solid pet food component of the first aspect of the invention may be in the range of from 5 to 30%, optionally from 15 to 20% (on a wet weight basis).

The protein may be derived from one or more of the following sources: poultry, pork, beef, lamb, fowl and any other animal, game, fish, crustacean, shell fish, larvae, worm, insect, yeast, plant, algae, microalgae, seaweed, fungi, microorganisms or maize gluten powder, each in the form of a particulate, such as meal or powder or slurry or paste (together with a lubricant, such as water) and/or the whole native material.

The protein may be a low functional protein.

A low functional protein is a protein with hardness of no more than 150±20 [(g/g of chunk)*20% protein] when measured in the form of chunk via a Texture Analyzer. The chunk is obtained by dispersing or dissolving the protein to provide a dispersion or solution (typically from a dry protein) or emulsion (typically from a wet protein) of about 20% protein content and a minimum moisture level of 40% and placing the solution into a silicon mold and heating for 8-10 minutes at 80-100° C. Optionally the chunk obtained is one that will not be intact if it is subsequently retorted while heating to 120° C. for at least 30 minutes.

The hardness is measured using a Texture Analyzer TA.XT Plus (Stable Microsystems). Suitably a high speed mixer is used (1000 rpm) to disperse or dissolve the protein in a solution or emulsion.

A steam oven is a suitable means for heating. Silicon muffin molds may be used e.g. molds having a diameter 3 cm; lower diameter 2.5 cm; height 2.5 cm to obtain chunks.

One suitable method for measuring the hardness is to prepare a solution or emulsion containing about 20% protein from the raw material. The dispersion, solution or emulsion should comprise at least 40% moisture. The solution or emulsion can be prepared using a high speed kitchen mixer, at roughly 1000 rpm. The solution or emulsion is then placed in the silicon mold and heated for 8-10 minutes at 80-100° C. in the steam oven. The solution or emulsion is then cooled for at least 10 minutes; if necessary, with the use of ice cubes. The obtained chunks are then retorted in a 100 g pouch, and the pouch filled with water up to 100 g total weight. The sterilization program is set at a temperature higher than 110° C. for at least 30 minutes. The texture of the non-retorted chunk is measured via TA Texture Analyzer, single compression, 50% deformation.

The solid pet food component may comprise only the protein, curdlan and water or it may comprise other ingredients, such as additional protein, other hydrocolloids, flavours, colourants, vitamins, minerals, carbohydrate and/or fat.

A second hydrocolloid may be present in the solid pet food component. Such a second hydrocolloid may be one or more of carrageenan, cassia, xanthan, pectin, alginate, agar gum, cellulose, methylcellulose, guar gum, gellan gum, galactomannans, konjac gum, carob gum, starch, modified starch, waxy starch, Arabic gum, karaya gum, tara gum, gum ghatti, gelatin, or any other hydrocolloid from a microbial, plant or animal source. Such a second hydrocolloid may be present in an amount of 0.05 to 25% (on a wet weight basis). The preferred total hydrocolloid in the component product is from 0.05 to 30% (on a wet weight basis).

Flavour may be added to give food a particular taste or smell and may be derived from natural ingredients or artificially created. Flavours include one or more products of the Maillard reaction.

The solid component of the first aspect of the invention is a material which is effective as a component for pet food products, in particular moist pet food products. Typically, moist pet food products are formed as (and are known as) chunks in gravy and/or chunks in jelly products or formed as a meat loaf product. The first aspect of the invention may also be incorporated into other pet food products, such as semi-moist products or as a distinct portion within a dry kibble product (such as in the form of a “pocket” product), as well as snacks and treats.

The composition according to the first aspect of the invention may be incorporated into any product which an animal, such as a dog or a cat, may consume in its diet. The term animal in this text includes any animal that could benefit from or enjoy the consumption of the food compositions of the present invention, including canine and/or feline animals. Most preferably, the animal is a pet dog or pet cat. Thus the invention covers standard food products, supplements, pet food, snacks, care and treats. The food product is preferably a cooked product.

The size of the solid pet food component of the first aspect of the invention will vary and depends on the animal that is consuming the pet food. The size can range in length from 5 mm to 200 mm, preferably 10 mm to 100 mm, more preferably 20 mm to 80 mm, and even more preferably 5 mm to 20 mm, in particular when used to form the second aspect of the invention.

The second aspect of the invention relates to a moist pet product comprising a total moisture content of 40% to 90% and being in the form of solids in gravy or solids in jelly product, wherein a solids comprise or are a solid pet food component.

The moist pet food of the second aspect of the invention may contain between 10 to 50% by weight of the solid pet food component of the first aspect, or 15 to 40% by weight or 20 to 35% by weight of the solid pet food of the second aspect of the invention. The second aspect of the invention, in terms of a moist pet food comprises the solid pet food and other ingredients to form a moist pet food. The other ingredients may be in the form of a gravy or jelly (to form a solids/chunks in gravy or jelly product) or meat or other ingredients to form, for example, a meat loaf product. Meat loafs are usually prepared by comminuting raw meat material and gelling agents and optionally mixing it with water, salt, spices, curing agents. The mixture is combined with the solid pet food component of the first aspect of the invention. The mixture is then filled into cans to form, after retorting and cooling, a meat loaf.

The gravy or jelly comprises one or more additional ingredients selected from the group consisting of a liquid carrier e.g. water, fats or oils, a thickening agent and flavouring agents. The gravy or jelly is generally a coating material which surrounds the meat like chunk. The gravy or jelly will likely contain a thickening agent which is used to control its consistency.

The flavouring agents such as, beef flavour and meat flavour, can be used in amounts sufficient to impart the desired flavour. It is possible to provide further nutritional ingredients in the moist pet food to achieve a nutritionally balanced pet food. Nutritional ingredients may include one or more of meat and other animal products, raw meaty bones, boneless meat, fish, organs, eggs, dairy products, fruits and vegetables, grains, supplements such as minerals, fish oil, cod liver oil, plant oils, vitamins and iodine. The product is preferably sterilised.

A third aspect of the invention provides a method of making a solid pet food component according to the first aspect of the invention. Such a method involves mixing curdlan, protein and any other ingredient to a mixture of at least 40% water, heating to at least 80° C., optionally for at least 60 seconds and allowing the product to cool, with optional shaping and cutting. The other ingredient should be food grade ingredients. The forming of the solid pet food component is carried out according to processes known in the art. These include processes to form the component by extrusion through nozzles and/or heating. Some form of further hydrocolloid may be added during the process. The ingredients to make the component are mixed and heated/extruded sufficiently (optionally with pressure) to solidify the mixture. Heating temperatures from 90-150° C., preferably 100-120° C. for 1 to 10 minutes, preferably about 1 minute. The cooled product is then cut into portions/chunks as desired.

One method used to form the solid pet food component is described in WO 00/69276 and uses higher-moisture extrusion techniques to create a Higher Moisture Extruded Chunk. U.S. Pat. No. 4,247,562 also describes the process of making such solid pet food components. In general the pet food component is produced using a heated extruder to combine ingredients along with water. In the extruder, the mixture is plasticised and heated to form a hot, viscous and at least partly molten mass (i.e. protein lava). The extruder barrels and screw then mixes, heats, coagulates, expands and shears the mixture into a meat-like mass which is then formed into different shapes and cut by standard knives. Another method used to form the solid pet food includes the use of a steam tunnel to cook the combined ingredients. The mixture or meat emulsion is extruded in the form of ropes, which are then cut into the meat-like chunks by standard knives. The steam tunnel is a conveyor system that transports the product through the steam installation. The ropes are long strings of meat emulsion or mixture that are pumped through nozzles of variable size. The products are blanched or cooked with saturated steam which is injected from above and below the conveyor belt which exposes the product to a continual and even application of steam to ensure it is cooked thoroughly.

A particular advantage of the present invention is the use of standard processing and equipment to form the solid pet food component.

A fourth aspect of the invention relates to making a wet pet food product according to the second aspect of the invention, the method comprising adding the solid pet food component according to the first aspect of the invention with the remaining food ingredients of the wet pet food and subjecting the mixture to sterilisation. The sterilisation is preferably a thermal treatment exceeding 110° C.

Thus the method comprises the steps of combining gravy, jelly, meat or meat batter to the solid pet food component, optionally heating and optionally packaging the product.

The moist pet food may be a meat loaf, optionally wherein the solid pet food of the first aspect of the invention comprises from 5% to 90% by weight of the loaf, or 20% to 60% by weight or 20% to 50%, or 1 to 25% by weight of the meat loaf.

After the solid pet food component is made (optionally diced or cubed to an appropriate size) it/they are placed in a can or other package. The solid pet food component may be added to the can while a hot or cold gravy solution or jelly-type material (e.g. 65° C. to 95° C.), may be poured over the product to produce a ready-to-eat meat like chunk in gravy or in jelly. This method allows the meat like chunk to warm up and untrapped gases to be expelled prior to closing the packaging. The filled packages/cans may be vacuum closed and processed using commercially acceptable sterilisation techniques. Alternatively, ingredients are added to the solid pet food component of the first aspect of the invention and packaged, where the ingredients, in the usual sterilisation process, result in the formation of a jelly or gravy mixed with the solid pet food component in the package.

In various embodiments, the solids to gravy ratio and/or jelly ratio is about 20:80, 30:70, 40:60, 45:55, 50:50, 55:45 and 60:40.

The methods of the invention may include the step of packaging the moist pet food. The packaging may be in a can (tin) or jar (e.g. glass) or otherwise a plastic, metal, foil pouch, or flexifoil, all of which can be sealed.

A fifth aspect of the invention provides the use of a combination of curdlan and a protein in forming a solid pet food component as described according to the above-mentioned aspects of the invention.

In the preparation of pet food products generally, ingredient selection can have a high impact on pet food texture, uniformity, extrudability, nutritional quality and ability to accept high levels of fat and water to provide the aforementioned qualities. The present invention provides products which provide the desired solid texture, organoleptic properties and appearance.

The present invention will now be described with reference to the following non-limiting examples:

### EXAMPLES

In the following examples the term “chunk” is used synonymously with solid pet food component according to the first aspect of the invention.

### Example 1

This Example aimed at showing the feasibility to utilize curdlan in chunk production at kitchen scale, formulated with proteins of very low functionality. The objectives are:
showing that curdlan is able to set up chunks made from low functional meat ingredients
showing that these chunks are stable to retorting

### Materials:

Chicken by-product (the chicken material is treated at 90° C. for 10 minutes to de-functionalise it and cooled to −18° C.).
Curdlan (CUD)
Xanthan (XG)

Chicken by-product was choosen as low functional protein source. This by-product is low functional. In the absence of curdlan it can create a form of borderline meat chunks (which do not have a proper structure and do not stand retortion), and which that can be used as a “0 control” recipe in the experiments.

### List of Equipment:

Bowl chopper (8 kg batch)
Emulsifier (8 kg batch)
Kitchen mixer (Kroner)
Kitchen balance
9 mm nozzle+plastic bags for pastry
Steam oven
100 g pouches
Pouch sealer
Retort

### Methods

### Preparation of the Emulsion

Chicken by-product was weighed frozen and ground in the bowl chopper for 5 minutes at low speed and 2 minutes at high speed. After this operation, the material was transferred to the emulsifier and passed through the circulating knives. The gap between the knives is 0.5 mm. This operation permits to have an emulsion which is still below 0° C. The emulsion thus obtained was stored at 4° C. waiting to be used in the kitchen to prepare the recipes.

### Preparation of the Recipes

Chicken by-product was mixed with the other ingredients at kitchen scale using a kitchen mixer. 1 kg batches were prepared for every recipe. First, the chicken by product emulsion was weighed in the bowl, then the powders were added; the Kroner mixer was activated at max speed for 10 seconds and then stopped to scratch the powders from the wall; after this operation, the mixer was activated again for 2 minutes to mix the emulsion+powder properly.

### Preparation of the Ropes, Cooking and Cutting in Chunks

The chicken by product emulsion was then piped to be a rope shaped by 9 mm diameter nozzle and cooked in the 100° C. steam oven for 2 minutes. The ropes were cooled for 2 minutes and cut into a length of 7 mm to obtain chunks.

### Preparation of the Pouches

The chunks were put in 100 g transparent pouches, which were then filled with tap water to imitate the gravy part of wet petfood. The proportion between chunks and water was 35:65. The pouches were then sealed with the pouch sealer and sterilized in the retort.

### Measurements

### Measurement on Fresh Chunks

The hardness of the chunks was measured by TA-TX2i Texture Profile Analyzer with the texture exponent 32 software. The 5 kg load cell (force sensitivity: 0.1 g) was applied for the right amount of force. A chunk was placed on the bottom plate and the upper apparatus presses it to the 50% of its original height with return distance of 15 mm, return speed of 10 mm/sec and contact force of 10 g. The chunk was weighed as well to normalize the hardness of every chunk by its weight. The peak of the force (at point 2) which occurs during the compression represents the hardness (g) of a chunk. Twenty randomly selected chunks per production batch were measured and the hardness values were averaged.

### Results

In the table below, the recipes tested in Example 1 are listed. For each recipe, the inclusion level of curdlan is reported. Additionally, the inclusion level of the second hydrocolloid (xanthan) is reported.

For each recipe, the hardness (g/g) of each chunk as measured via Texture Analyzer is reported, both before and after sterilization.

As written hereinbefore, a low functional protein (like the one present in the chicken by product of this Example) is not able to create chunks with a hardness level higher than 150±20 g/g or cannot withstand sterilization.

In the results given below, every recipe containing curdlan optionally and the second hydrocolloid xanthan presents a hardness way higher than the one mentioned above and can withstand sterilization to retain its shape.

| Chicken | | | Hardness | Hardness | | Moisture |
|---|---|---|---|---|---|---|
| meat by | | | before | after | Can it | content |
| product | Curdlan | Xanthan | sterilization | sterilization | withstand | calculated |
| (g) | (g) | (g) | (g/g) | (g/g) | sterilization? | [%] |
| 1000 | 0 | 0 | 150 ± 20 | N/A | No | 72.0 |
| 990 | 10 | 0 | 459 ± 27 | 678 ± 34 | Yes | 71.4 |
| 980 | 20 | 0 | 575 ± 39 | 789 ± 48 | Yes | 70.7 |
| 970 | 30 | 0 | 746 ± 68 | 879 ± 60 | Yes | 70.1 |
| 960 | 40 | 0 | 915 ± 59 | 963 ± 85 | Yes | 69.5 |
| 989.5 | 10 | 0.5 | 430 ± 34 | 675 ± 58 | Yes | 71.3 |
| 979.5 | 20 | 0.5 | 561 ± 31 | 676 ± 58 | Yes | 70.7 |
| 969.5 | 30 | 0.5 | 718 ± 55 | 789 ± 53 | Yes | 70.1 |
| 989 | 10 | 1 | 420 ± 30 | 627 ± 59 | Yes | 71.3 |
| 979 | 20 | 1 | 518 ± 43 | 666 ± 32 | Yes | 70.7 |
| 969 | 30 | 1 | 671 ± 41 | 675 ± 59 | Yes | 70.0 |
| 988.5 | 10 | 1.5 | 386 ± 28 | 583 ± 46 | Yes | 71.3 |
| 978.5 | 20 | 1.5 | 496 ± 46 | 675 ± 59 | Yes | 70.6 |
| 968.5 | 30 | 1.5 | 635 ± 51 | 627 ± 59 | Yes | 70.0 |

The chicken-by-product used was Chicken viscera. This material has a moisture level of 72%.

All the Curdlan used had a moisture content of 9%.

The Cassia Gum had a moisture content of 10%

The Carob Gum had a moisture content of 9,5%.

The Xanthan gum had a moisture level of 11%.

The Waxy maize starch had a moisture content of 12%.

In all cases a moisture level of more than 69% was used, as shown in the table.

### Example 2

### Materials

Chicken by-product (the chicken material was treated at 90° C. for 10 minutes to de-functionalise it and cooled to −18° C.
Curdlan (CUD)
Cassia gum
Waxy maize starch
Carob gum
   List of equipment
   Same as Example 1
   Methods
   Same as Example 1
   Measurements
   Same as Example 1
   Results

In the table below, the recipes that were tested in Example 2 are listed. For each recipe, the inclusion level of curdlan is reported. Additionally, the inclusion level of a second hydrocolloid (cassia, waxy maize starch, carob) is reported.

For each recipe, the hardness (g/g) of each chunk as measured via Texture Analyzer is reported, both before and after sterilization.

As written hereinbefore, a low functional protein (like the one present in the chicken by product of this Example) is not able to create chunks with a hardness level higher than 150±20 g/g or cannot withstand sterilization.

In the results given below, every recipe containing curdlan optionally and the second hydrocolloid presents a hardness way higher than the one mentioned above and can withstand sterilization to retain its shape.

| Chicken | | | Second | Hardness | Hardness | | Moisture |
|---|---|---|---|---|---|---|---|
| meat by | | Second | hydrocolloid | before | after | Can it | content |
| product | Curdlan | hydrocolloid | weight | sterilization | sterilization | withstand | calculated |
| (g) | (g) | type | (g) | (g/g) | (g/g) | sterilization? | [%] |
| 1000 | 0 | — | 0 | 150 ± 20 | N/A | No | 72.0 |
| 985 | 10 | Cassia | 5 | 268 ± 20 | 497 ± 43 | Yes | 71.1 |
| 975 | 20 | Cassia | 5 | 376 ± 21 | 641 ± 47 | Yes | 70.4 |
| 965 | 30 | Cassia | 5 | 502 ± 42 | 692 ± 40 | Yes | 69.8 |
| 980 | 10 | Cassia | 10 | 291 ± 26 | 502 ± 46 | Yes | 70.8 |
| 970 | 20 | Cassia | 10 | 357 ± 33 | 585 ± 40 | Yes | 70.1 |
| 960 | 30 | Cassia | 10 | 480 ± 46 | 633 ± 33 | Yes | 69.5 |
| 985 | 10 | Carob | 5 | 253 ± 21 | 535 ± 43 | Yes | 71.1 |
| 975 | 20 | Carob | 5 | 330 ± 26 | 589 ± 26 | Yes | 70.4 |
| 965 | 30 | Carob | 5 | 425 ± 25 | 624 ± 23 | Yes | 69.8 |
| 980 | 10 | Carob | 10 | 276 ± 17 | 493 ± 27 | Yes | 70.7 |
| 970 | 20 | Carob | 10 | 320 ± 23 | 484 ± 27 | Yes | 70.1 |
| 960 | 30 | Carob | 10 | 449 ± 36 | 522 ± 38 | Yes | 69.5 |
| 985 | 10 | Waxy starch | 5 | 320 ± 31 | 509 ± 35 | Yes | 71.1 |
| 975 | 20 | Waxy starch | 5 | 388 ± 36 | 520 ± 33 | Yes | 70.4 |
| 965 | 30 | Waxy starch | 5 | 492 ± 30 | 653 ± 52 | Yes | 69.8 |
| 980 | 10 | Waxy starch | 10 | 293 ± 31 | 412 ± 34 | Yes | 70.8 |
| 970 | 20 | Waxy starch | 10 | 408 ± 32 | 499 ± 31 | Yes | 70.1 |
| 960 | 30 | Waxy starch | 10 | 525 ± 46 | 599 ± 37 | Yes | 69.5 |

The chicken-by-product used was Chicken viscera. This material has a moisture level of 72%.

All the Curdlan used had a moisture content of 9%.

The Cassia Gum had a moisture content of 10%

The Carob Gum had a moisture content of 9,5%.

The Xanthan gum had a moisture level of 11%.

The Waxy maize starch had a moisture content of 12%.

In all cases a moisture level of more than 69% was used, as shown in the table.

### Example 3

### Materials

Maize gluten
Water
Curdlan (CUD)

Maize gluten was chosen as a source of low functional protein source. A paste of 35:65 gluten:water was prepared. In the absence of curdlan, this paste does not have functionality in terms of aggregation and it is not capable of creating a solid chunk under the conditions described below for the combination with curdlan.

List of equipment
Bowl chopper (8 kg batch)
Kitchen mixer (Kroner)
Kitchen balance
9 mm nozzle+plastic bags for pastry
Steam oven
100 g pouches
Pouch sealer
Retort

Methods

### Preparation of the Emulsion (“Paste”)

The weighed amount of maize gluten was added to the bowl chopper together with water and mixed until a homogenous mix was obtained.

### Preparation of the Recipes

The above mentioned paste was mixed with other ingredients (i.e. curdlan) using a high shear mixer (Kroner) in batches of 1 kg. First, the paste was weighed in the bowl, then the powders were added; the Kroner mixer was activated at max speed for 10 seconds and then stopped to scratch the powders from the wall; after this operation, the mixer was activated again for 2 minutes to mix the paste and powder properly.

### Preparation of the Ropes, Cooking and Cutting in Chunks

The above mentioned mix (paste and powder) was then piped to be a rope shaped by 9 mm diameter nozzle and cooked in the 100° C. steam oven for 2 minutes. The ropes were cooled for 2 minutes and cut into a length of 7 mm to obtain chunks.

### Preparation of the Pouches

The chunks were put in 100 g transparent pouches, which were then filled with tap water to imitate the gravy part of wet petfood. The proportion between chunks and water was 35:65. The pouches were then sealed with the pouch sealer and sterilized in the retort.

### Measurements

Same as Example 1

### Results

In the table below, the recipes that were tested in Example 3 are listed. For each recipe, the inclusion level of curdlan is reported. For each recipe, the hardness (g/g) of each chunk as measured via Texture Analyzer is reported, both before and after sterilization.

As written hereinbefore, a low functional protein (like maize gluten) is not able to create chunks without the presence of curdlan.

In the results given below, every recipe containing curdlan is able to create solid chunks with a hardness higher than 150±20 g/g and can withstand sterilization to retain its shape.

| Maize | | Hardness | | Moisture |
|---|---|---|---|---|
| gluten | | before | Can it | content |
| paste | Curdlan | sterilization | withstand | calculated |
| (g) | (g) | (g/g) | sterilization? | [%] |
| 1000 | 0 | None | No | 68.5 |
| 980 | 20 | 457.09 | Yes | 68.5 |
| 970 | 30 | 623.74 | Yes | 68.5 |
| 960 | 40 | 721.02 | Yes | 68.5 |
| 950 | 50 | 927.44 | Yes | 68.5 |
| 940 | 60 | 1017.41 | Yes | 68.5 |
| 930 | 70 | 1162.65 | Yes | 68.5 |
| 920 | 80 | 1387.07 | Yes | 68.5 |

This example shows that adding curdlan to the recipe enables the creation of solid chunks.

The addition of curdlan in this model recipe is correlated linearly with the hardness increase. Indeed, as curdlan concentration increases by 1%, hardness increases on average by approximately 149 g/g.

Maize gluten/corn gluten has a moisture level of 10%.

A 35% water mixture and 65% corn gluten mixture has a moisture level of 41,5%.

The moisture content of the Curdlan was 9%.

1. (canceled)

2. A wet pet food product comprising:
a moisture content of 40 to 90%; and
a solid pet food component comprising:
a mixture of curdlan and 5 to 30% protein on a wet weight basis;
a moisture content of at least 40%; and
a hydrocolloid comprising one or more of carrageenan, cassia, xanthan, pectin, alginate, agar gum, cellulose, methylcellulose, guar gum, gellan gum, galactomannans, konjac gum, carob gum, starch, modified starch, waxy starch, Arabic gum, karaya gum, tara gum, gum ghatti, gelatin, or any other hydrocolloid from a microbial, plant or animal source,
wherein the protein is in particulate form, and the solid pet food component of the wet pet food product is a gravy or in a jelly to form a wet pet food product that is a solids in gravy product or a solids in jelly product.

3. The wet pet food product of claim 2, wherein the protein is derived from one or more of poultry, pork, beef, lamb, fowl, game, fish, crustaceans, shellfish, larvae, worm, insects, yeast, plant, algae, microalgae, seaweed, fungi, microorganisms or maize gluten powder, each in the form of one or more of meal, powder, slurry or the whole native material, optionally wherein the protein is a low functional protein.

4. The wet pet food product of claim 2, wherein the curdlan is present in the range of from 0.05% to 25% (on a wet weight basis).

5. The wet pet food product of claim 2, wherein a total hydrocolloid content is from 0.05 to 30% on a wet weight basis.

6. A method of making a wet pet food product comprising:
mixing curdlan and protein to form a mixture;
heating the mixture to at least 80° C.;
allowing the heated mixture to cool to form a solid pet food component;
mixing the solid pet food component with gravy, jelly, meat, or meat batter to form a second mixture; and
sterilizing the second mixture to form a wet pet food component.
